(19) United States
(12) Patent Application Publication
(10) Pub. No.: US 2026/0348462 A1
(43) Pub. Date: Nov. 5, 2026

(54) POWER TRANSMISSION APPARATUS

(71) Applicant: KANZAKI KOKYUKOKI MFG. CO., LTD., Amagasaki-shi (JP)

(72) Inventors: Yuki HASHIMOTO, Amagasaki-shi (JP); Koji KIYOOKA, Amagasaki-shi (JP); Hiroaki HASHIMA, Amagasaki-shi (JP)

(21) Appl. No.: 19/661,922

(22) Filed: Apr. 29, 2026

(30) Foreign Application Priority Data
Apr. 30, 2025 (JP) 2025-075864

(51) Int. Cl. F16H 47/04; F16H 57/02; F16H 57/037; F16H 57/04

(52) U.S. Cl. CPC F16H 47/04; F16H 57/037; F16H 57/043; F16H 57/045; F16H 57/0471; F16H 57/0486; F16H 2057/02026; F16H 2057/02052

(57) ABSTRACT

[Problem] Provided is a power transmission apparatus that can be made compact in the vertical direction while suppressing generation of vibration and noise associated with power transmission, thereby improving the ride comfort of the vehicle. [Solution] The power transmission apparatus of the present invention comprises: an input shaft that receives power from the prime mover and whose longitudinal axis extends along a front-rear direction of the vehicle; an HMT unit that receives power from the input shaft and stepless changes the speed by a combination of an HST mechanism including a hydraulic pump and a hydraulic motor, and a planetary gear mechanism; a rear wheel final reduction device with a differential mechanism that receives power from the HMT unit and is drivingly connected to the first drive wheel; and a low-profile housing that accommodates the input shaft, the HMT unit, and the rear wheel final reduction device, wherein: the input shaft is located on a left-right central side of the housing and protrudes from a surface on one side in the front-rear direction facing the prime mover; the HMT unit is disposed on one of left and right sides of the housing; and the rear wheel final reduction device is disposed on the other side in the front-rear direction of the housing.

### CROSS REFERENCE TO RELATED APPLICATIONS

The present invention claims priority under 35 U.S.C. § 119 to Japanese Application No. 2025-075864, filed on Apr. 30, 2025, the entire contents of which being incorporated herein by reference.

### TECHNICAL FIELD

The present invention relates to a transmission for driving drive wheels of a vehicle.

### BACKGROUND ART

Conventionally, a utility vehicle is known that includes, beneath a cargo bed, an internal combustion engine (hereinafter referred to as a prime mover) mounted with its crankshaft oriented in a front-rear direction of the vehicle, and a HMT (hydro-mechanical transmission) type power transmission apparatus that stepless changes the speed of the power from the prime mover and transmits it to traveling parts such as front wheels and rear wheels (see, for example, Patent Document 1).

### PRIOR ART DOCUMENT

### Patent Document

Patent Document 1: U.S. Pat. No. 7,617,892

### SUMMARY OF INVENTION

### Technical Problem

However, in the configuration disclosed in Patent Document 1, since the prime mover, which is a heavy component, is disposed offset to one of the left and right sides of the vehicle, the left-right weight balance of the vehicle is poor, and there is room for improvement in terms of traveling stability.

In order to facilitate left-right weight balance in this type of vehicle, it is preferable to position the prime mover, which is a heavy component, at a central side in the vehicle width direction (central side in the front-rear and left-right directions) beneath the cargo bed. Since the power transmission apparatus receives power from the prime mover and mainly drives the rear wheels, it is rational to dispose the power transmission apparatus near them. Therefore, the power transmission apparatus is also disposed beneath the cargo bed. However, if the vertical dimension of the power transmission apparatus is large, the volume of the cargo bed is naturally reduced, and therefore the power transmission apparatus needs to be configured as compactly as possible in the space beneath the cargo bed.

Furthermore, depending on the positional relationship between the prime mover and the transmission, the inclination angle of a first propeller shaft that transmits power output from the prime mover to the transmission increases. In such a case, the load on the universal joints disposed at both ends of the first propeller shaft increases, and there is a concern that large vibrations and noise are generated, which deteriorates the ride comfort of the vehicle and accelerates deterioration of the universal joints.

### Solution to Problem

The present invention has been made against the background of the above-described current situation and has a technical object to provide the power transmission apparatus capable of suppressing generation of vibration and noise while achieving compactness, thereby improving the ride comfort of the vehicle.

The present invention is the power transmission apparatus for driving a first drive wheel of a vehicle, comprising: an input shaft that receives power from the prime mover and whose longitudinal axis extends along a front-rear direction of the vehicle, an HMT unit that receives power from the input shaft and stepless changes the speed by a combination of an HST mechanism including a hydraulic pump and a hydraulic motor, and a planetary gear mechanism, a rear wheel final reduction device with a differential mechanism that receives power from the HMT unit and is drivingly connected to the first drive wheel, a low-profile housing that accommodates the input shaft, the HMT unit, and the rear wheel final reduction device, wherein, the input shaft is located on a left-right central side of the housing and protrudes from a surface on one side in the front-rear direction facing the prime mover, the HMT unit is disposed on one of left and right sides of the housing, the rear wheel final reduction device is disposed on the other side in the front-rear direction of the housing.

The transmission of the present invention may further comprise the following.

That is, the transmission comprises a pump shaft of the hydraulic pump and a motor shaft of the hydraulic motor that are parallel to each other with respect to the input shaft, wherein the pump shaft is offset to one side in the vertical direction relative to the input shaft, and the motor shaft is offset to the other side in the vertical direction relative to the input shaft, an input power transmission gear train that transmits power of the input shaft to the HMT unit, and a travel drive gear train that transmits a speed-changed output of the HMT unit to the rear wheel final reduction device.

The transmission of the present invention may further comprise the following.

That is, a carrier and an internal gear of the planetary gear mechanism are arranged to be rotatable relative to each other on a rotational axis of the motor shaft. One of the carriers and the internal gear is drivingly connected to the input power transmission gear train, and the other of the carrier and the internal gear is drivingly connected to the travel drive gear train.

The transmission of the present invention may further comprise the following.

That is, the transmission comprises an input counter gear included in the input power transmission gear train, a pump input gear drivingly connected to the pump shaft, external teeth provided on the carrier, and external teeth provided on the internal gear. The input counter gear meshes with the pump input gear and also meshes with one of the external teeth, and the other of the external teeth is drivingly connected to the travel drive gear train.

The transmission of the present invention may further comprise the following.

That is, the transmission comprises an HST case detachably mounted on one of left and right sides of the housing as a part thereof, the HST case accommodating the hydraulic pump and the hydraulic motor.

The transmission of the present invention may further comprise the following.

That is, the transmission comprises an oil sump formed within the housing, a planet pin supported by the carrier of the planetary gear mechanism, a planet gear provided on the planet pin so as to be rotatable via a bearing, a lubrication passage formed in the planet pin and configured to guide oil stored in the housing to the bearing, and an oil supply hole formed in an outer surface of the carrier and communicating with the lubrication passage.

In the transmission of the present invention, the following configuration may be adopted.

That is, the outer surface of the carrier faces an inner wall surface of the housing that rotatably supports the carrier.

### Advantageous Effects of Invention

According to the present invention, the HMT unit and the first traveling drive shaft are allocated to one side and the other side, respectively, in the left-right direction with the input shaft interposed therebetween, the pump shaft and the motor shaft are allocated vertically one above the other, and the input power transmission gear train and the travel drive gear train are arranged in parallel in the vertical direction in the housing.

Therefore, considering the pitch circle diameters and the like of the respective gears of the gear trains, it is possible to narrow the vertical arrangement interval between the shafts of the input power transmission gear train and the shafts of the travel drive gear train. This enables the power transmission apparatus to be made compact in the vertical direction. If the vertical dimension of the transmission is made compact, it is possible, for example, to lower the ground clearance of the cargo bed to increase the cargo bed volume, to raise the minimum ground clearance of the vehicle to avoid interference with the road surface, or to lower the center of gravity of the vehicle to improve traveling stability.

Furthermore, by positioning the input shaft on the left-right central side of the housing, even when the prime mover, which is a heavy component, is positioned at the front-rear and left-right central side of the vehicle (midship layout), it is easy to reduce the inclination angle of the first propeller shaft connecting the prime mover and the transmission. Therefore, generation of vibration and noise associated with power transmission can be suppressed, and the ride comfort of the vehicle can be improved.

### BRIEF DESCRIPTION OF DRAWINGS

FIG. 1 is a schematic side view of a utility vehicle as a vehicle.

FIG. 2 is a skeleton diagram showing a power transmission system of the utility vehicle.

FIG. 3 is a skeleton diagram of a transmission case.

FIG. 4 is a schematic front view showing a gear train inside the transmission case with the HST case and the cover omitted.

FIG. 5 is a partially cutaway plan sectional view showing an upper half of the transmission case.

FIG. 6 is a plan sectional view showing a lower half of the transmission case.

FIG. 7 is a side sectional view showing the HMT unit of the transmission case.

FIG. 8 is an enlarged side sectional view of the planetary gear mechanism showing a lubrication mode of hydraulic oil.

FIG. 9 is an enlarged rear view of the carrier.

FIG. 10 is an enlarged side sectional view of the HMT unit showing another example in which the pump shaft also serves as the input shaft.

### DESCRIPTION OF EMBODIMENTS

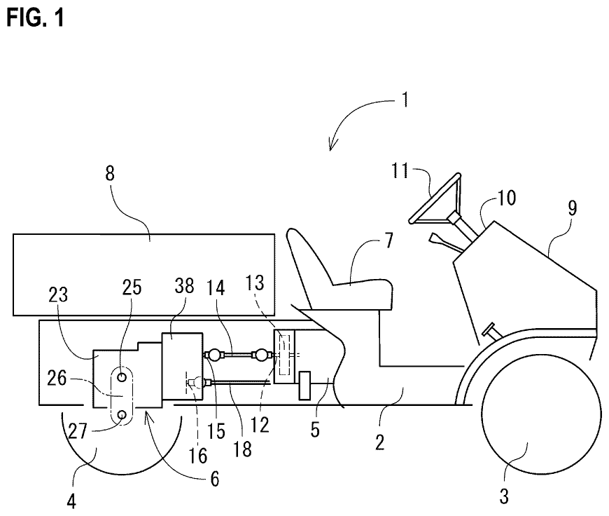

Hereinafter, embodiments embodying the present invention will be described with reference to the drawings (FIG. 1 to FIG. 10). Although the drawings show preferred embodiments, the present invention can be implemented in many different forms, and the technical scope of the present invention is not limited to the embodiments described in this specification. In the following description, the terms “front-rear” and “left-right” are used to specify directions, and are based on the traveling direction of the vehicle 1. The direction intersecting the front-rear traveling direction is defined as the left-right direction (vehicle width direction) of the vehicle 1. However, these terms are used only for convenience of explanation and do not limit the technical scope of the present invention.

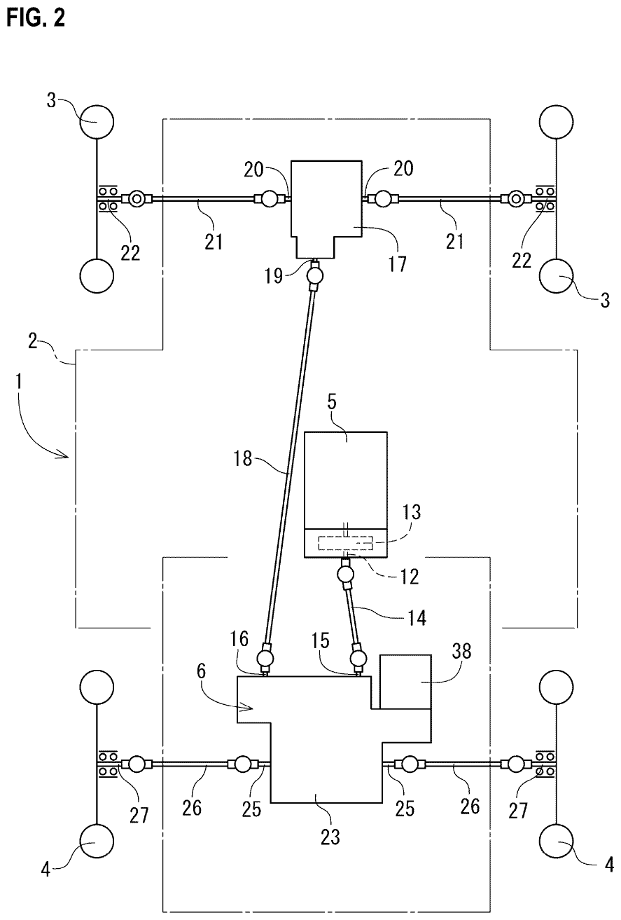

An overview of the utility vehicle 1 adopted as the vehicle of the embodiment will be described with reference to FIG. 1 and FIG. 2. A body frame 2 of the vehicle 1 suspends a pair of left and right rear wheels 4 as first drive wheels and a pair of left and right front wheels 3 as second drive wheels via a suspension mechanism (not shown). An internal combustion engine as a prime mover 5 is mounted at a substantially central portion in the front-rear and left-right directions of the body frame 2. A transmission case 6 corresponding to a housing of the power transmission apparatus is mounted at a rear portion of the body frame 2. The vehicle 1 is configured to travel forward and backward by two-wheel drive with the rear wheels 4, or by four-wheel drive by also driving the front wheels 3 as needed, by transmitting power from the prime mover 5 to the transmission case 6. Examples of the utility vehicle include recreational vehicles (RVs) and all-terrain vehicles (ATV).

The driver's seat 7 is arranged above the power source 5 and is supported on the body frame 2. Rearward of the driver's seat 7 (above the transmission case 6), the cargo bed 8 is arranged and supported on the body frame 2. The cargo bed 8 is tiltable up and down about a laterally extending dump shaft (not shown) provided at a rear portion of the body frame 2 as a fulcrum. A hood 9 is provided at a front portion of the body frame 2. On a rear upper side of the hood 9, a steering column 10 is provided, and a steering wheel 11 for steering the front wheels 3 is disposed on the steering column 10.

The transmission case 6 is formed in a low-profile configuration as a whole such that the lateral dimension when mounted on the vehicle is longer than the vertical dimension.

A flywheel 13 is directly connected to an output shaft 12 of the prime mover, which is disposed so as to protrude rearward from the prime mover 5 along the front-rear direction of the vehicle 1. The flywheel 13 of the prime mover 5 is drivingly connected to an input shaft 15 protruding forward from the left-right central side of the front surface of the transmission case 6 via the first propeller shaft 14 having universal joints at both ends.

An HST case 38 accommodating a hydraulic pump 32 and a hydraulic motor 33 is detachably mounted on one of left and right sides (the right side in the embodiment) of the front surface of the transmission case 6 (details will be described later). A front wheel output shaft 16 protrudes forward from the other of the left and right sides (the left side in the embodiment) of the front surface of the transmission case 6.

A front wheel final reduction device 17 with a differential mechanism is provided at the front portion of the body frame 2. The front wheel output shaft 16 protruding from the transmission case 6 is drivingly connected to a front wheel introduction shaft 19 protruding rearward from the front wheel final reduction device 17 via a second propeller shaft 18 having universal joints at both ends. A front axle 22 of the front wheel 3 is drivingly connected to a front wheel differential yoke shaft 20 protruding outward to the left and right from the front wheel final reduction device 17 via a front wheel transmission shaft 21 having universal joints at both ends. The front wheels 3 are steered wheels and are configured to be steerable to the left and right in conjunction with a steering operation of the steering handle 11.

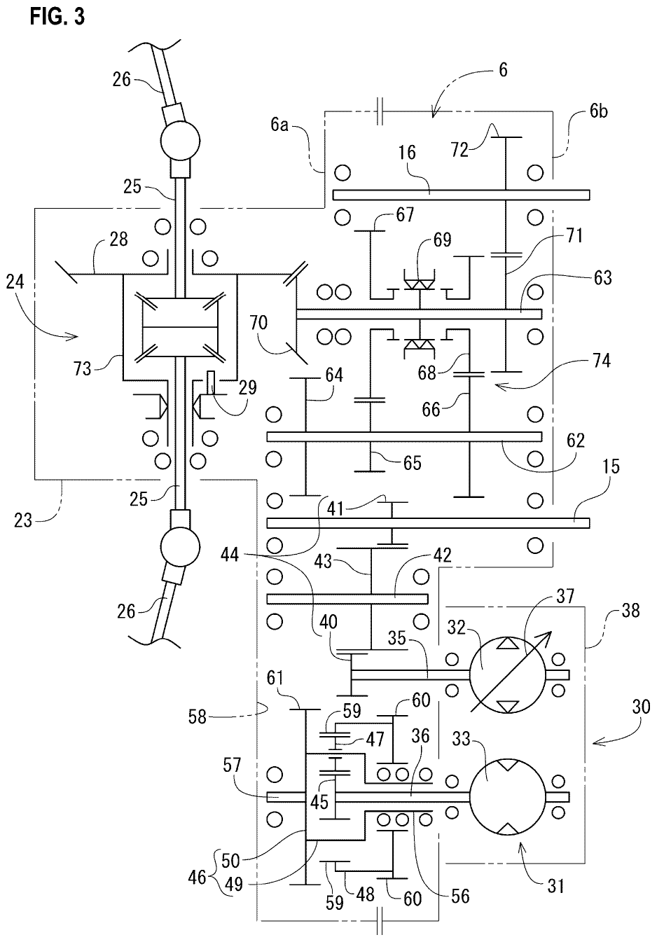

A rear wheel final reduction device 24 with a differential mechanism is disposed on the other side in the front-rear direction (the rear side in the embodiment) of the transmission case 6. In the present embodiment, a rear transmission case portion 23 protruding rearward is integrally provided on the main case portion 6a forming the transmission case 6. The rear wheel final reduction device 24 is accommodated in the rear transmission case portion 23 (see FIG. 3). A rear axle 27 of the rear wheel 4 is drivingly connected to a rear wheel differential yoke shaft 25 protruding outward to the left and right from the rear wheel final reduction device 24 via a rear wheel transmission shaft 26 having universal joints at both ends. That is, in the vehicle 1 of the embodiment, the power transmitted from the prime mover 5 to the transmission case 6 can be output to the front wheels 3 via the front wheel final reduction device 17 and can also be output to the rear wheels 4 via the rear wheel final reduction device 24.

The rear wheel final reduction device 24 is provided with a differential lock mechanism 29 that can be switched on and off to stop the differential function and constantly drive the left and right rear wheel differential yoke shafts 25 at a constant speed (see FIG. 3). The main case portion 6a is constituted by a peripheral wall portion integrally formed so as to open the front end thereof, and a cover portion 6b that closes the opening. In the sealed space formed in the main case portion 6a, each of the input shaft 15, sub-transmission shaft (as a first traveling drive shaft) 63, the output counter shaft 62, the front wheel output shaft 16, the input cylinder shaft 39, and the input counter shaft 42 is supported so as to be parallel to each other along the front-rear direction of the vehicle.

The differential lock mechanism 29 of the embodiment is electrically operated, and an electromagnetic solenoid 79 for operating the differential lock mechanism 29 is attached to the right outer surface of the rear transmission case portion 23.

Next, the details of the internal structure (power transmission system) of the transmission case 6 will be described with reference to FIG. 3 to FIG. 9. The HMT unit 30, the input shaft 15, and the sub-transmission shaft 63 are accommodated in the transmission case 6 mounted at the rear portion of the body frame 2.

The HMT unit 30 changes the speed of power from the prime mover 5 by a combination of the HST mechanism 31 and the planetary gear mechanism 34. The HMT unit 30 of the embodiment transmits the power transmitted to the input shaft 15 to the pump shaft 35 of the hydraulic pump 32 and the internal gear 48 of the planetary gear mechanism 34. On the other hand, the constant-speed power transmitted to the internal gear 48 and the speed-changed power output from the motor shaft 36 of the hydraulic motor 33 are combined by the planetary gear mechanism 34 to drive the sub-transmission shaft 63. That is, the HMT unit 30 of the embodiment is configured as an output-split type in which the output of the HST mechanism 31 is input to the planetary gear mechanism 34.

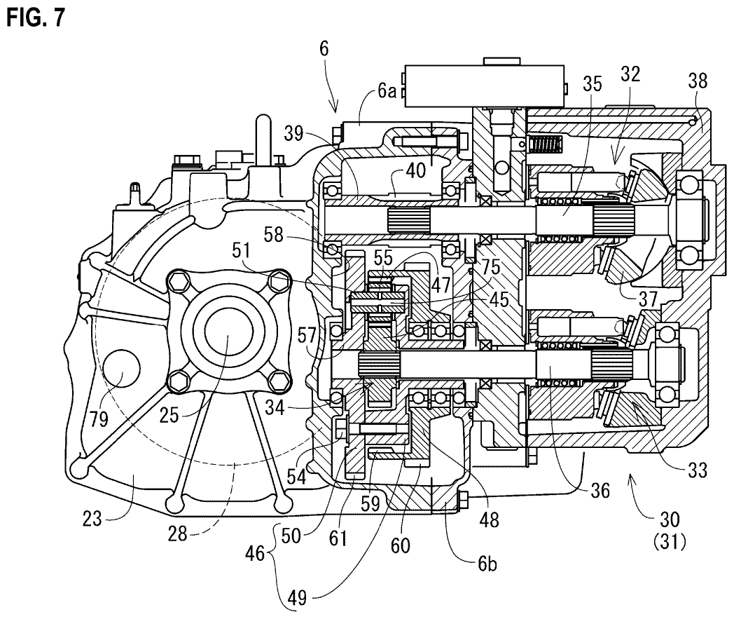

The HST mechanism 31 is configured to adjust the rotation direction and rotation speed of the motor shaft 36 of the hydraulic motor 33 by adjusting the inclination angle of the movable swash plate 37 (see FIG. 3 and FIG. 7) of the hydraulic pump 32 to change the discharge direction and discharge amount of hydraulic oil to the hydraulic motor 33.

The hydraulic pump 32 and the hydraulic motor 33 of the embodiment are integrally unitized by being accommodated in the HST case 38 detachably attached externally to one of the left and right sides (the right side in this case) of the front surface of the transmission case 6. For example, when performing maintenance on components such as the hydraulic pump 32 and the hydraulic motor 33, it suffices to remove the HST mechanism 31 from the transmission case 6 while leaving the transmission case 6 mounted on the vehicle body frame 2.

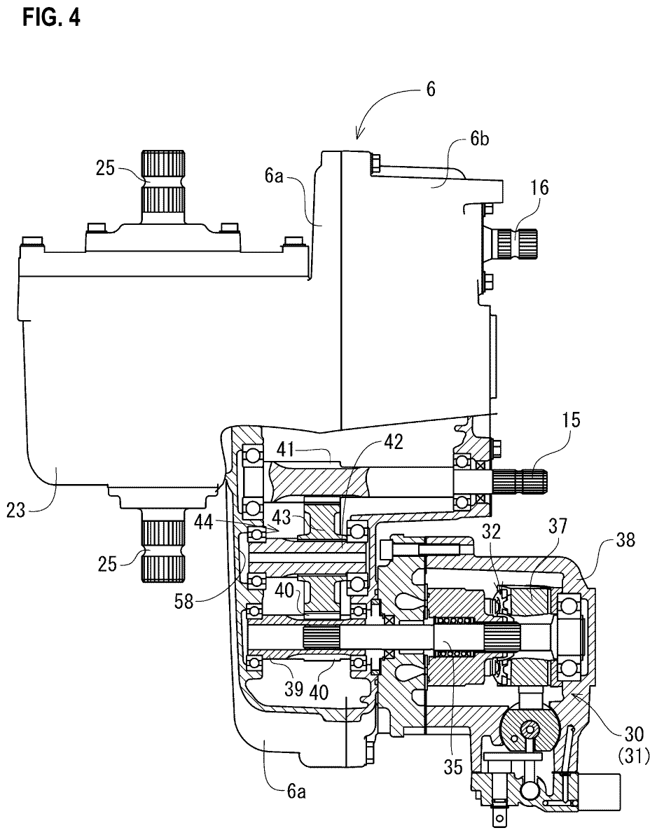

As shown in FIG. 4 and FIG. 7, the pump shaft 35 of the hydraulic pump 32 and the motor shaft 36 of the hydraulic motor 33 are parallel to each other with respect to the input shaft 15, and the pump shaft 35 is disposed on one side in the vertical direction (the upper side in the embodiment) relative to the position of the input shaft 15, and the motor shaft 36 is disposed on the other side in the vertical direction (the lower side in the embodiment) relative to the position of the input shaft 15.

In the present embodiment, the pump shaft 35 and the motor shaft 36 are arranged along the vertical direction relative to each other, but they may be offset in the left-right direction. For example, the motor shaft 36 may be positioned closer to the input shaft 15 or, conversely, farther away therefrom.

The hydraulic pump 32 and the hydraulic motor 33 are arranged in parallel in the HST case 38. The pump shaft 35 and the motor shaft 36 are each rotatably supported by the HST case 38 via bearings. Rear end portions of the pump shaft 35 and the motor shaft 36 are inserted into the transmission case 6.

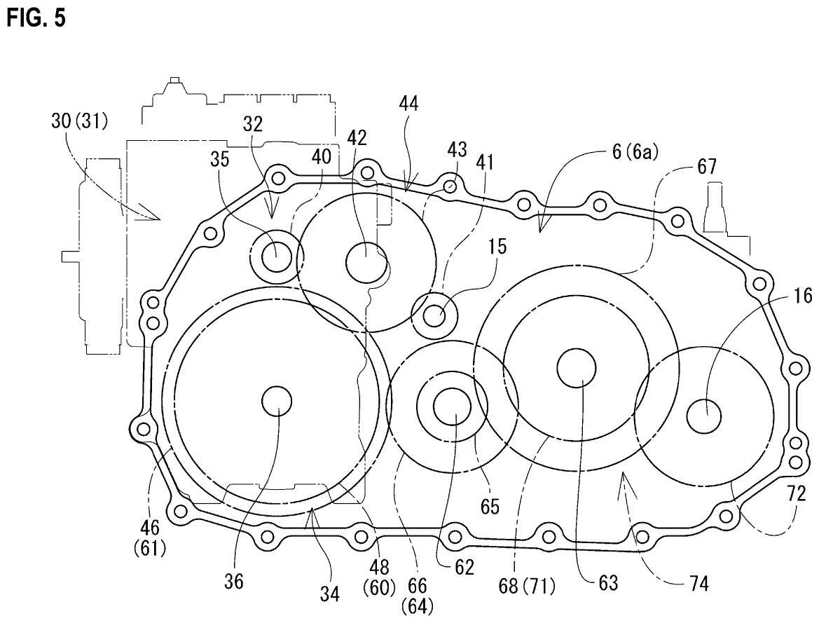

The input cylinder shaft 39 is rotatably supported by the main case portion 6a and the cover portion 6b of the transmission case 6 (see FIG. 5). A recess is formed at the front end of the input cylinder shaft 39 and is exposed outward through the front opening of the cover portion 6b. The rear end of the pump shaft 35 has a length protruding rearward from the HST case 38. When the HST case 38 is attached to the cover portion 6b, the rear end of the pump shaft 35 is inserted into the recess of the input cylinder shaft 39 and is connected so as not to be relatively rotatable, for example, via a spline.

A pump input gear 40 is provided on the input cylinder shaft 39. In the present embodiment, the pump input gear 40 is integrally formed on the outer periphery of the input cylinder shaft 39.

The input shaft 15 is rotatably supported by the transmission case 6. The longitudinal axis of the input shaft 15 extends along the front-rear direction of the vehicle 1. The front end side of the input shaft 15 is located on the left-right central side (vehicle width direction central side) of the transmission case 6 and protrudes forward from the front surface of the cover portion 6b (see FIG. 2 to FIG. 5).

As shown in FIG. 4, on the front surface of the cover portion 6b, a mounting area for the HST case 38 is defined so that the HST mechanism 31 can be attached toward one of the left and right sides. This enables the input shaft 15 to protrude without interfering with the HST case 38.

Power from the prime mover 5 is transmitted to the input shaft 15 via the flywheel 13 and the first propeller shaft 14. The input shaft 15 is provided with an input gear 41 that is non-rotatable relative thereto. In the embodiment, the input gear 41 is integrally formed on the outer periphery of the input shaft 15.

As shown in FIG. 3 to FIG. 5, the pump shaft 35, the motor shaft 36, the input shaft 15, and the input counter shaft 42 are arranged in parallel with each other along the front-rear direction in the transmission case 6. As shown in FIG. 4, the input counter shaft 42, the pump shaft 35, and the internal gear 48 are arranged such that their rotational axes form a triangle. A wide input counter gear 43 is fixed to the input counter shaft 42, which is rotatably supported by the transmission case 6, so as not to be relatively rotatable by spline fitting or the like. The input counter gear 43 meshing with the input gear 41 of the input shaft 15 meshes with the pump input gear 40 of the pump shaft 35 (the input cylinder shaft 39) and also meshes with the external teeth 60 of the internal gear 48.

In the upper portion of the transmission case 6, the input shaft 15, the input counter shaft 42, and the pump shaft 35 are arranged side by side in the lateral direction (direction perpendicular to the axial direction) from the left-right central side to the right side. The motor shaft 36 is located directly below the pump shaft 35.

The input gear 41 of the input shaft 15, the input counter gear 43 of the input counter shaft 42, and the pump input gear 40 of the pump shaft 35 (the input cylinder shaft 39) constitute an input power transmission gear train 44 for drivingly connecting the input shaft 15 and the HMT unit 30 (the hydraulic pump 32 of the HST mechanism 31). The power from the prime mover 5 transmitted to the input shaft 15 drives the hydraulic pump 32 of the HST mechanism 31 via the input power transmission gear train 44.

The planetary gear mechanism 34 constituting the HMT unit 30 is disposed below the input cylinder shaft 39 in the transmission case 6.

The planetary gear mechanism 34 has a carrier 46, and a pair of front and rear hollow shaft portions 56 and 57 provided on its rotation center are rotatably supported by bearings on the main case portion 6a and the cover portion 6b, respectively. The front end of the hollow shaft portion 56 is located at an opening provided in the bearing portion of the cover portion 6b and is exposed at the front surface.

The motor shaft 36 has a length extending rearward beyond the rear surface of the HST case 38. When the HST mechanism 31 is attached to the front surface of the cover portion 6b, the rear end of the motor shaft 36 is inserted into the hollow shaft portion 56 and is spline-fitted to a sun gear 45 described later to drive the sun gear 45. The planetary gear mechanism 34 has a plurality of planet gears 47 (three in the embodiment) meshing with the sun gear 45. All of the planet gears 47 are rotatably supported by the carrier 46 on the same radius.

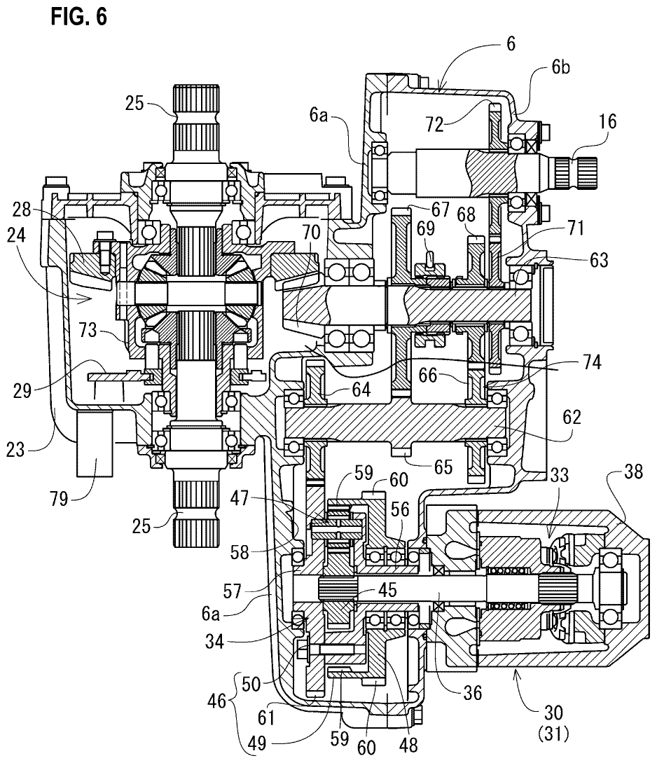

As shown in FIG. 6 to FIG. 9, the carrier 46 of the embodiment is composed of a pair of disk bodies 49 and 50 that are separably coupled to face each other in the rotation axis direction (front-rear direction). The hollow shaft portions 56 and 57 are integrally formed outward on the rotation centers of the first and second disk bodies 49 and 50. The planet pin 51 is supported by the first disk body 49 and the second disk body 50. In this case, the inner surfaces of the respective disk bodies 49 and 50 are provided with a plurality of holes 52 and 53 (three each in the embodiment) along the circumferential direction for supporting the planet pin 51. The first disk body 49 and the second disk body 50 are fastened by bolts 54 from the second disk body 50 side. The planet gear 47 is rotatably supported on the planet pin 51 via a bearing 55 (needle roller bearing in the embodiment).

The internal gear 48 is supported on the hollow shaft portion 56 of the first disk body 49 via a bearing, and the internal gear 48 is rotatable relative to the carrier 46. The internal gear 48 has an inner peripheral tooth portion 59 and outer peripheral external teeth 60 arranged side by side along the axial direction.

The hollow shaft portion 57 of the second disk body 50 is rotatably supported via a bearing on an inner wall surface 58 on one of the left and right sides (the right side in the embodiment) of the rear portion of the transmission case 6. The rear side surface (outer surface) of the second disk body 50 faces the rear inner wall surface 58 of the transmission case 6 in close proximity.

The sun gear 45 meshes with the radially inner portion of the planet gear 47. The tooth portion 59 of the internal gear 48 meshes with the radially outer portion of the planet gear 47. The external teeth 60 of the internal gear 48 constantly mesh with the input counter gear 43 of the input counter shaft 42.

External teeth 61 are formed on the outer peripheral side of the second disk body 50 of the carrier 46. The external teeth 61 constantly mesh with an output counter gear 64 fixed to the output counter shaft 62 so as not to be relatively rotatable.

As shown in FIG. 3, FIG. 4, and FIG. 6, in the lower portion of the transmission case 6, the output counter shaft 62, the sub-transmission shaft 63, and the front wheel output shaft 16 are arranged in parallel toward the other side in the left-right direction with respect to the motor shaft 36 positioned on one side in the left-right direction. The output counter shaft 62, the sub-transmission shaft 63, and the front wheel output shaft 16 are each rotatably supported across the main case portion 6a and the cover portion 6b of the transmission case 6. An output counter gear 64, a low-speed relay gear 65, and a high-speed relay gear 66 are fixed to the output counter shaft 62 in order from the rear side so as not to be relatively rotatable. In the embodiment, the output counter gear 64 and the high-speed relay gear 66 are spline-fitted to the output counter shaft 62. The low-speed relay gear 65 is formed on the output counter shaft 62.

A low-speed gear 67 constantly meshing with the low-speed relay gear 65 and a high-speed gear 68 constantly meshing with the high-speed relay gear 66 are installed on the sub-transmission shaft 63 in an idling state. A sub-transmission clutch 69 is disposed between the low-speed gear 67 and the high-speed gear 68 on the sub-transmission shaft 63 so as to be slidable in the axial direction for selectively engaging either the low-speed gear 67 or the high-speed gear 68 with the sub-transmission shaft 63. By moving the sub-transmission clutch 69 toward the low-speed gear 67 or the high-speed gear 68 in conjunction with an operation of a sub-transmission operating tool (not shown) on the steering column 10 and engaging one of them, two-stage reduction ratios of low and high can be provided to the sub-transmission shaft 63.

As a result, when the speed-change output of the HMT unit 30 reaches the sub-transmission shaft 63 from the output counter shaft 62, it is adjusted to either low or high reduction ratio. In this embodiment, when the sub-transmission clutch 69 is not engaged with either the low-speed gear 67 or the high-speed gear 68, power transmission from the HST mechanism 31 is interrupted, and the sub-transmission shaft 63 can be idled.

The rear wheel final reduction device 24 with a differential mechanism is disposed behind the sub-transmission shaft 63. The rear wheel final reduction device 24 includes, as is customary, a differential input gear 28, a differential gear case 73, a pair of the rear wheel differential yoke shafts 25 protruding outward to the left and right from the differential gear case 73, and four bevel gears. The differential input gear 28 meshes with a pinion 70 provided at the rear end of the sub-transmission shaft 63. Therefore, the speed-change output transmitted to the sub-transmission shaft 63 is transmitted from the pinion 70 at the rear end to the rear wheel final reduction device 24 via the differential input gear 28, and connects the left and right of the rear wheels 4 so as to be differentially rotatable via the rear wheel differential yoke shaft 25, the rear wheel transmission shaft 26, and the rear axle 27. Therefore, the sub-transmission shaft 63 as a first traveling drive shaft is drivingly connected to the rear wheels 4 as first drive wheels.

The longitudinal axis of the front wheel output shaft 16 also extends along the front-rear direction of the vehicle 1. As described above, the front end side of the front wheel output shaft 16 protrudes forward from the other of the left and right sides (the left side in the embodiment) of the front surface of the transmission case 6 (see FIGS. 2 to 6). A front wheel output gear 72 meshing with a front wheel relay gear 71 provided at the front portion of the sub-transmission shaft 63 is disposed at the front portion of the front wheel output shaft 16. The front wheel relay gear 71 is fitted to the sub-transmission shaft 63 so as not to be relatively rotatable by spline fitting or the like. The front wheel output gear 72 is fitted to the front wheel output shaft 16 so as not to be relatively rotatable by spline fitting or the like.

A clutch mechanism may be provided that fits the front wheel output gear 72 to the front wheel output shaft 16 so as to be relatively rotatable and that enables engagement and disengagement of the front wheel output gear 72 with respect to the front wheel output shaft 16.

The front wheel output shaft 16 outputs stepless speed-change power from the HMT unit 30 in a state capable of being switched between high and low two stages. As shown in FIG. 1, the speed-change power output to the sub-transmission shaft 63 is transmitted from the front wheel output shaft 16 to the front wheel final reduction device 17 via the second propeller shaft 18. Then, the left and right of the front wheels 3 are differentially driven via the front wheel differential yoke shaft 20, the front wheel transmission shaft 21, and the front axle 22 of the front wheel final reduction device 17.

In this embodiment, the external teeth 61 provided on the carrier 46 (the second disk body 50), the output counter gear 64, the low-speed relay gear 65, and the high-speed relay gear 66 on the output counter shaft 62, and the low-speed gear 67 and the high-speed gear 68 on the sub-transmission shaft 63 constitute the travel drive gear train 74 that transmits the speed-change output of the HMT unit 30 to the sub-transmission shaft 63 as a first traveling drive shaft. The speed-change output of the HMT unit 30 is transmitted to the sub-transmission shaft 63 via the travel drive gear train 74 to rotate the sub-transmission shaft 63. The external teeth 61 of the carrier 46 (the second disk body 50) constantly mesh with the output counter gear 64 of the output counter shaft 62 extending in parallel with the input shaft 15 and the like. That is, the external teeth 61 of the carrier 46 (the second disk body 50) are drivingly connected to the travel drive gear train 74.

As shown in FIG. 3, FIG. 4, and FIG. 6, the HMT unit 30 and the sub-transmission shaft 63 as a first traveling drive shaft are allocated to one side and the other side, respectively, in the left-right direction with the input shaft 15 interposed therebetween. In the embodiment, the HMT unit 30 is positioned on the right side of the transmission case 6, and the sub-transmission shaft 63 is positioned on the left side of the transmission case 6. Also, as can be seen from the fact that the pump shaft 35 and the motor shaft 36 are arranged vertically, the input power transmission gear train 44 and the travel drive gear train 74 are arranged in parallel in the vertical direction in the transmission case 6. The input shaft 15 is located on the left-right central side of the transmission case 6. The front end side of the input shaft 15 protrudes forward from the left-right central side of the front surface of the transmission case 6.

In the embodiment, the input counter gear 43 of the input power transmission gear train 44 meshes with the external teeth 60 of the internal gear 48, and the external teeth 61 of the carrier 46 mesh with the output counter gear 64 of the output counter shaft 62 constituting the travel drive gear train 74, but this is not limiting. The input counter gear 43 may mesh with the external teeth 61 of the carrier 46, and the external teeth 60 of the internal gear 48 may mesh with the output counter gear 64 of the output counter shaft 62. In this case, the HMT unit 30 is also an output-split type in which the output of the HST mechanism 31 is input to the planetary gear mechanism 34.

According to the above configuration, the HMT unit 30 and the sub-transmission shaft 63 are allocated to one side and the other side, respectively, in the left-right direction with the input shaft 15 interposed therebetween, the pump shaft 35 and the motor shaft 36 are allocated vertically, and the input power transmission gear train 44 and the travel drive gear train 74 are arranged in parallel in the vertical direction in the transmission case 6. Therefore, considering the pitch circle diameters and the like of the respective gears of the gear trains 44 and 74, it is possible to narrow the vertical arrangement interval between the shaft group 15, 35, 42 of the input power transmission gear train 44 and the shaft group 36, 62, 63 of the travel drive gear train 74. This enables the transmission case 6 to be made compact in the vertical direction. Even when the transmission case 6 is disposed beneath the cargo bed 8, if the transmission case 6 is compact in vertical dimension, it is not necessary to layout the cargo bed 8 high while ensuring minimum ground clearance, so the center of gravity of the vehicle 1 can be lowered to improve traveling stability.

In the embodiment, since the input shaft 15 is positioned on the left-right central side of the transmission case 6, when the prime mover 5 is in a midship layout positioned toward the left-right center of the vehicle 1 as shown in FIG. 2, it is easy to reduce the bending angle in the left-right direction of the first propeller shaft 14 connecting the prime mover 5 and the transmission case 6. Therefore, generation of vibration and noise associated with power transmission can be suppressed, and the ride comfort of the vehicle 1 can be improved.

Furthermore, the carrier 46 and the internal gear 48 of the planetary gear mechanism 34 are each provided with the external teeth 60 and 61, respectively, and are arranged to be rotatable relative to each other on the rotational axis of the motor shaft 36. By disposing the planetary gear mechanism 34 on the motor shaft 36, the transmission case 6 (excluding the rear transmission case portion 23) can be made compact in the front-rear direction.

Moreover, one of the external teeth 60 of the carrier 46 and the external teeth 61 of the internal gear 48 is drivingly connected to the input power transmission gear train 44. The other is drivingly connected to the travel drive gear train 74. The input counter gear 43, which is positioned between the input gear 41 and the pump input gear 40 and constitutes the input power transmission gear train 44, also meshes with the external teeth 60 of the carrier 46, thereby simplifying the input power transmission gear train 44.

Moreover, in the embodiment, since the HST case 38 that accommodates the hydraulic pump 32 and the hydraulic motor 33 and rotatably supports the pump shaft 35 and the motor shaft 36 is detachably mounted on one of the left and right sides of the front surface of the transmission case 6, the HST mechanism 31 can be easily replaced, and maintainability can be improved.

Next, the lubrication structure of the planetary gear mechanism 34 in the embodiment will be described mainly with reference to FIG. 7 to FIG. 9. In this embodiment, the transmission case 6 also functions as an oil sump, and the oil is stored in the transmission case 6. The oil is used for cooling and lubricating gears, bearings, and the like present in the transmission case 6, and may also be hydraulic oil for the HST mechanism 31. The oil level S of the oil charged in a predetermined amount is set low enough to constantly immerse the lower half of the planetary gear mechanism 34 and the travel drive gear train 74 (oil bath state), thereby reducing horsepower loss due to oil stirring resistance by gears.

The planetary gear mechanism 34 and the travel drive gear train 74 located in the lower portion of the transmission case 6 are cooled and lubricated by being immersed in the oil. Also, the input power transmission gear train 44 and the like located in the upper portion of the transmission case 6 are cooled and lubricated by oil splash associated with rotation of the planetary gear mechanism 34 and the travel drive gear train 74.

As described above, the inner surfaces of the respective disk bodies 49 and 50 of the carrier 46 are provided with a plurality of support holes 52 and 53 (three each in the embodiment) along the circumferential direction into which both ends of the planet pin 51 are inserted. When the first disk body 49 and the second disk body 50 are fastened by the bolt 54, the planet pin 51 is clamped. The planet gear 47 is rotatably provided on the planet pin 51 via the bearing 55 (needle roller bearing in the embodiment).

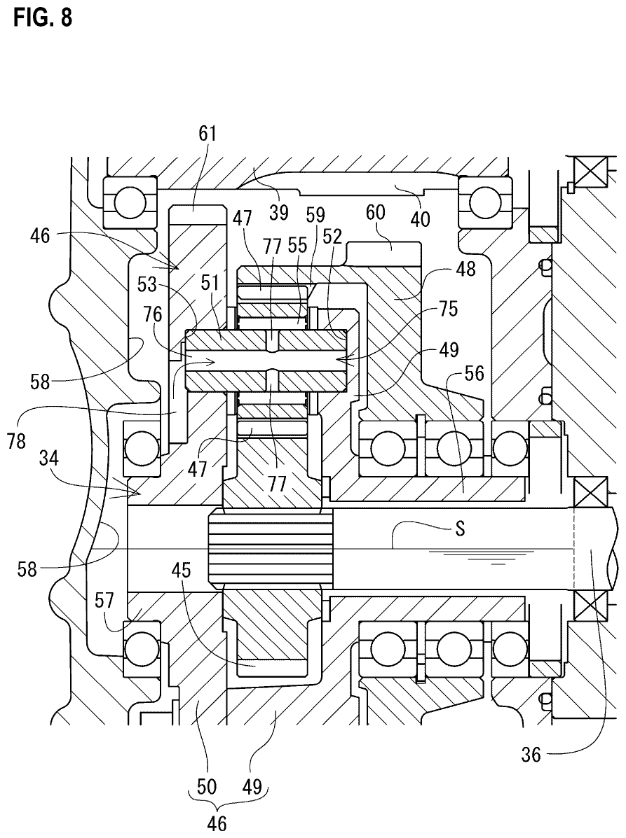

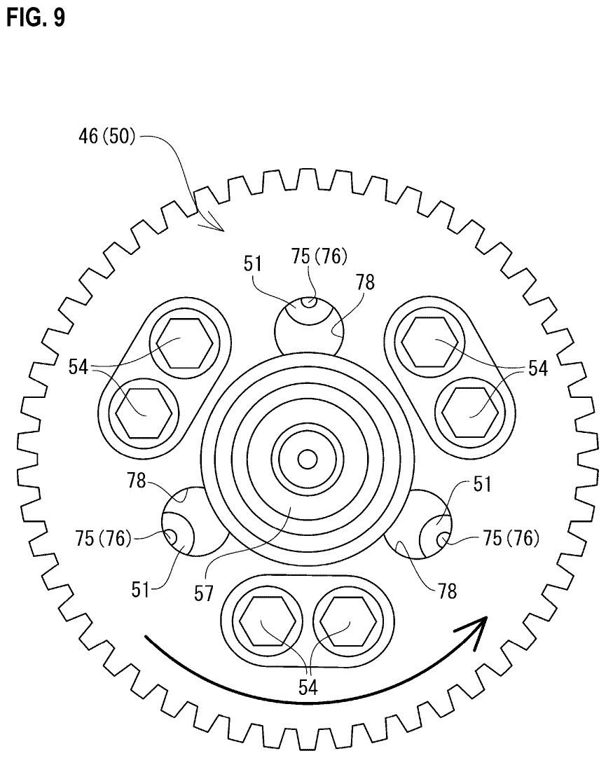

As shown in FIG. 8 and FIG. 9, a cross-shaped lubrication passage 75 for guiding oil stored in the transmission case 6 to the bearing 55 is formed in the planet pin 51. An inlet 76 of the lubrication passage 75 is opened at least on the end surface of the planet pin 51 on the side inserted into the support hole 53 of the second disk body 50. Two outlets 77 of the lubrication passage 75 are opened on the outer peripheral surface of the planet pin 51. The outlets 77 face the bearing 55 between the planet pin 51 and the planet gear 47.

An oil supply hole 78 that is offset in the radial direction from the corresponding support hole 53 and communicates with the support hole 53 is formed on the outer surface of the second disk body 50 of the carrier 46. In the embodiment, three oil supply holes 78 corresponding to each of the planet pins 51 are formed on the outer surface of the second disk body 50. The oil supply hole 78 is located radially inward and communicates with the inlet 76 of the lubrication passage 75 via the support hole 53.

When the outer surface of the second disk body 50 is viewed from the direction of the motor shaft 36, a portion of the inlet 76 of the lubrication oil passage 75 is exposed at a radially outer location corresponding to the oil supply hole 78. The outer surface of the carrier 46 (the second disk body 50) faces, with a predetermined clearance, the rear inner wall surface 58 of the mission case 6 that rotatably supports a hollow shaft portion 57 of the second disk body 50. When the second disk body 50 rotates in the oil sump, the oil surface S in the vicinity of its outer periphery tends to be drawn upward along the disk surface due to viscous adhesion. At this time, the narrower the gap between the second disk body 50 and the rear inner wall surface 58, the higher the rise position (maintainable height) of the oil surface S becomes.

As used herein, the “predetermined clearance” means a gap set such that oil drawn upward is stably maintained at a height near the rotational locus of the oil supply hole 78, and oil constantly reaches the oil supply hole 78 while the vehicle is traveling.

According to the above configuration, while reducing agitation resistance of the oil, the rotation of the second disk body 50 allows the scooped-up oil to be caught by or immersed into the oil supply hole 78, and, by utilizing rotational centrifugal force, the oil can be supplied continuously and smoothly via the lubrication passage 75 to the bearing 55 of the planet gear 47 for lubrication. Therefore, the durability of the planet gear 47, the planet pin 51, and the bearing 55 can be improved.

In a particular embodiment, the outer surface of the carrier 46 (the second disk body 50) in which the oil supply hole 78 is formed is disposed facing, in close proximity to, the rear inner wall surface 58 of the mission case 6. As a result, the space between the outer surface of the carrier 46 (the second disk body 50) and the front inner wall surface 58 of the transmission case 6 is narrowed, forming a flow path (narrow-gap region) through which the passage of oil is less likely to occur. Consequently, an outflow path (escape path) of oil flung up by the planetary gear mechanism 34 can be restricted, making it easier to retain and hold oil in the vicinity of the rotational locus of the oil supply hole 78. Accordingly, the oil can be efficiently captured by the oil supply hole 78, and the oil can be stably supplied through the lubrication passage 75 and hence to the bearing 55 of the planet gear 47.

Note that the configuration of the respective parts in the present invention is not limited to the illustrated embodiment, and various modifications can be made without departing from the spirit of the invention. As for the vehicle, it is not limited to the vehicle 1, and various types of vehicles can be adopted as long as they are equipped with the transmission of the present invention.

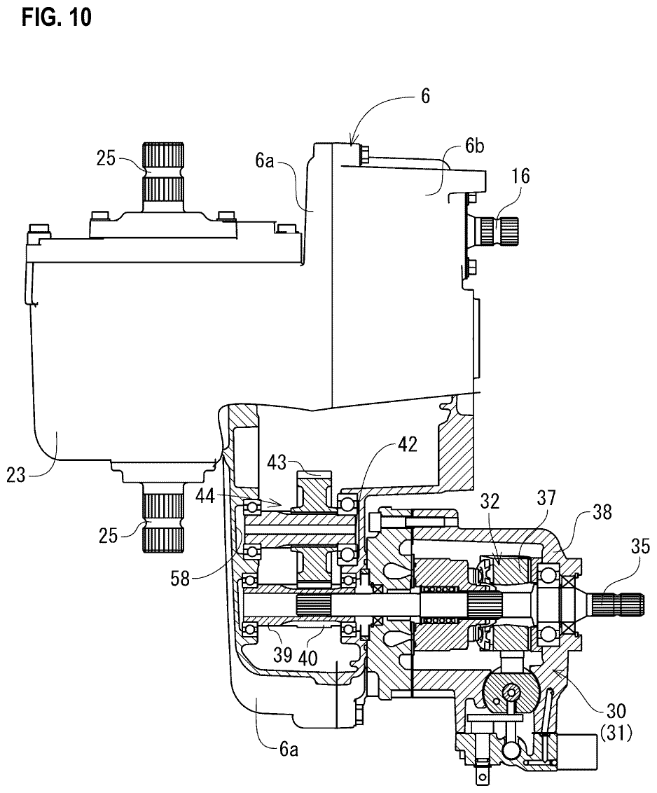

Furthermore, as in another example shown in FIG. 10, the pump shaft 35 of the hydraulic pump 32 may be protruded forward from the HST case 38, and the protruding end side of the pump shaft 35 may be drivingly connected to the flywheel 13 of the prime mover 5 via the first propeller shaft 14 (universal joint shaft) having universal joints. That is, the function of the input shaft 15 of the embodiment may be combined with the pump shaft 35. In this case, the pump input gear 40 of the pump shaft 35 may be meshed with the external teeth 60 or 61 of either one of the carrier 46 and the internal gear 48, and the external teeth 61 or 60 of the other may be drivingly connected to the travel drive gear train 74. According to the above configuration, the input shaft 15, the input counter shaft 42, and the input power transmission gear train 44 can all be eliminated, thereby reducing the number of parts and manufacturing costs.

### REFERENCE SIGNS LIST

1: Utility vehicle (vehicle)
2: Body frame
3: Front wheel
4: Rear wheel (first drive wheel)
5: Prime mover (internal combustion engine)
6: Transmission case
7: Driver's seat
8: Cargo bed
9: Hood
10: Steering column
11: Steering handle
12: Prime mover output shaft
13: Flywheel
14: First propeller shaft
15: Input shaft
16: Front wheel output shaft
17: Front wheel final reduction device
18: Second propeller shaft
19: Front wheel introduction shaft
20: Front wheel differential yoke shaft
21: Front wheel transmission shaft
22: Front axle
23: Rear transmission case portion
24: Rear wheel final reduction device
25: Rear wheel differential yoke shaft
26: Rear wheel transmission shaft
27: Rear axle
28: Differential input gear
29: Differential lock mechanism
30: HMT unit
31: HST mechanism
32: Hydraulic pump
33: Hydraulic motor
34: Planetary gear mechanism
35: Pump shaft
36: Motor shaft
37: Swash plate
38: HST case
39: Input cylinder shaft
40: Pump input gear
41: Input gear
42: Input counter shaft
43: Input counter gear
44: Input power transmission gear train
45: Sun gear
46: Carrier
47: Planet gear
48: Internal gear
49: First disk body
50: Second disk body
51: Planet pin
52, 53: Support hole
54: Bolt
55: Bearing (needle roller bearing)
56, 57: Hollow shaft portion
58: Rear inner wall surface
59: Tooth portion
60, 61: External teeth
62: Output counter shaft
63: Sub-transmission shaft (first traveling drive shaft)
64: Output counter gear
65: Low-speed relay gear
66: High-speed relay gear
67: Low-speed gear
68: High-speed gear
69: Sub-transmission clutch
70: Pinion
71: Front wheel relay gear
72: Front wheel output gear
73: Differential gear case
74: Travel drive gear train
75: Lubrication passage
76: Inlet
77: Outlet
78: Oil supply hole

1. A transmission for a vehicle that transmits power output from a prime mover to a first drive wheel of the vehicle, comprising:
an input shaft that receives power from the prime mover and whose longitudinal axis extends along a front-rear direction of the vehicle;
an HMT unit that receives power from the input shaft and stepless changes the speed by a combination of an HST mechanism including a hydraulic pump and a hydraulic motor, and a planetary gear mechanism;
a rear wheel final reduction device with a differential mechanism that receives power from the HMT unit and is drivingly connected to the first drive wheel;
a low-profile housing that accommodates the input shaft, the HMT unit, and the rear wheel final reduction device, wherein:
the input shaft is located on a left-right central side of the housing and protrudes from a surface on one side in the front-rear direction facing the prime mover;
the HMT unit is disposed on one of left and right sides of the housing;
the rear wheel final reduction device is disposed on the other side in the front-rear direction of the housing.

2. The transmission according to claim 1, further comprising:
a pump shaft of the hydraulic pump and a motor shaft of the hydraulic motor that are parallel to each other with respect to the input shaft, wherein the pump shaft is offset to one side in the vertical direction relative to the input shaft, and the motor shaft is offset to the other side in the vertical direction relative to the input shaft;
an input power transmission gear train that transmits power of the input shaft to the HMT unit, and a travel drive gear train that transmits a speed-changed output of the HMT unit to the rear wheel final reduction device.

3. The transmission according to claim 2, further comprising:
a carrier and an internal gear of the planetary gear mechanism arranged to be rotatable relative to each other on a rotational axis of the motor shaft, wherein:
one of the carrier and the internal gear is drivingly connected to the input power transmission gear train; and
the other of the carrier and the internal gear is drivingly connected to the travel drive gear train.

4. The transmission according to claim 3, further comprising:
an input counter gear included in the input power transmission gear train;
a pump input gear drivingly connected to the pump shaft;
external teeth provided on the carrier;
external teeth provided on the internal gear, wherein:
the input counter gear meshes with the pump input gear and also meshes with one of the external teeth; and
the other of the external teeth is drivingly connected to the travel drive gear train.

5. The transmission according to claim 1, further comprising:
an HST case detachably mounted on one of left and right sides of the housing as a part thereof, the HST case accommodating the hydraulic pump and the hydraulic motor.

6. The transmission according to claim 3, further comprising:
an oil sump formed within the housing;
a planet pin supported by the carrier of the planetary gear mechanism;
a planet gear provided on the planet pin so as to be rotatable via a bearing;
a lubrication passage formed in the planet pin and configured to guide oil stored in the housing to the bearing; and
an oil supply hole formed in an outer surface of the carrier and communicating with the lubrication passage.

7. The transmission according to claim 6, wherein
the outer surface of the carrier faces an inner wall surface of the housing that rotatably supports the carrier.
